(19) United States
(12) Patent Application Publication
(10) Pub. No.: US 2008/0178075 A1
(43) Pub. Date: Jul. 24, 2008

(54) Configuration Data Store for Overriding a Web Application Configuration Involving Multiple Customers

(75) Inventors: Stephanie Ann Trethaway, Westford, MA (US); J. David Hill, Nashua, NH (US); William Raymond Fredette, Lyndeboro, NH (US); Richard Elliott Cox, Chelmsford, MA (US); Michael Andrew Gratton, Hollis, NH (US); Lisa Fong, Nashua, NH (US); Anand Rajaram, Westford, MA (US); Michael Baglio, Andover, MA (US); Mark Henry Beary, Medway, MA (US); Jonathan Villaseca Magsino, Arlington, MA (US); Michael Andrew Super, Merrimack, NH (US); Zheng Li, Nashua, NH (US)

Correspondence Address: PROSKAUER ROSE LLP, ONE INTERNATIONAL PLACE, BOSTON, MA, 02110, US

(73) Assignee: FMR Corp., Boston, MA (US)

(21) Appl. No.: 11/747,393

(22) Filed: May 11, 2007

Related U.S. Application Data
(60) Provisional application No. 60/885,989, filed on Jan. 22, 2007.

(51) Int. Cl. G06F 17/00; G06F 9/46; G06F 3/00

(52) U.S. Cl. 715/255; 719/328; 715/744

(57) ABSTRACT

Described are methods and apparatus, including computer program products, for overriding configuration for web application involving multiple customers. A user of one of the customers requests a Web page. A dynamic Web page is generated using default values associated with the user. At least one of the default values is overridden by an override value associated with a context. A plurality of contexts are defined for use in the dynamic generation of the Web page. The plurality of contexts include an organization context, a role context, and/or a point of claim context.

### CROSS REFERENCES TO RELATED APPLICATIONS

This application claims the benefit of U.S. Provisional Patent Application No. 60/885,989, entitled “Configuration Data Store for Overriding a Web Application Configuration Involving Multiple Customers,” filed on Jan. 22, 2007, the disclosure of which is hereby incorporated by reference.

### FIELD OF THE INVENTION

The present invention relates to configuration data store for overriding a Web application configuration involving multiple customers.

### BACKGROUND

The use of the Web to provide applications to users is increasing because of the lower cost of deploying Web based applications and the increased flexibility that users have while using Web based applications. The lower cost of deploying Web based applications stems from not having to install applications on the personal computer of each user. The user can be directed to the Web based application through the web browser (e.g., Microsoft® Internet Explorer®, Mozilla® Firefox) on the personal computer. The increased flexibility of Web based applications stem from the application not being dependent on an operating system (e.g., Microsoft® Windows, Red Hat® Enterprise Linux) but only dependent on the web browser that is on the user's display device. Web browsers are designed to be used on a variety of display device including personal digital assistants (PDA), cellular phones, laptops, personal computers, and/or other mobile computing devices.

The widespread adoption of web based applications creates a need for configuration data stores for saving the configuration data of the users of the system. Systems use configuration databases to store configuration data that can be accessed by applications to determine configuration settings. Different ideas have generally been taught about the use of configuration data. For example, U.S. published patent application number 2005/0222969 describes centralized configuration data management for distributed clients. In another example, U.S. Pat. No. 6,128,730 describes a method and apparatus for multilevel software configuration having administrator and software driven override limiting capabilities. These examples, however, do not provide any specific examples of data structures for a configuration data store to be used when providing back end Web applications that are applicable to multiple customers.

The increasing use of Web applications provides opportunities for serving not only multiple users, but multiple customers each with their own users. The expansion from multiple users to multiple customers with their own users presents challenges since each customer can have their own organizational structure, rules associated with data access, and/or role structure. The customization of the Web applications for the different structures and rules of each customer decreases the overall cost to the customer and increases the flexibility of the Web application to the customer. However, it is difficult if not impossible to provide back end Web applications that are configurable for each user of each customer based on the structures and rules of each customer because the configuration for each Web application and each back end Web application has to be customized for each user of each customer.

### SUMMARY OF THE INVENTION

The description describes methods and apparatus, including computer program products, for a configuration data store for overriding configuration for web applications involving multiple customers. The description includes a specific schema that can be used to advantageously provide configuration overrides in a multiple customer environment.

Properties of an application (e.g., value, command, field) can, for example, be maintained at various levels relative to a user application. The properties are generally specified when the application is developed. However, the properties need to be variable to allow for different characteristics depending on where the functionality of the application is used (e.g., point of claim context) and/or by whom (e.g., organization, role). The variations of the properties for the functional aspects of the application can, for example, be stored outside of the application so that the properties can be used by other applications.

In another aspect, there is a computer program product for overriding a Web application configuration involving multiple customers. The computer program product is tangibly embodied in an information carrier. The computer program product includes instructions being operable to cause data processing apparatus to define a plurality of contexts for use in dynamic Web page generation associated with a provided service. The plurality of contexts includes an organization context representing one or more customers of the provided service, a role context representing one or more roles used with the provided service, and a point of claim context representing one or more channels through which the provided service is provided. A request for a Web page is received. A dynamic Web page using a plurality of default values is generated. At least one of the default values is overridden using at least one context from the plurality of contexts.

In another aspect, there is a system for overriding a Web application configuration involving multiple customers. The system includes a profile service module, a channel module, and an application server. The profile service module defines a plurality of contexts for use in dynamic Web page generation associated with a provided service. The plurality of contexts includes an organization context representing one or more customers of the provided service, a role context representing one or more roles used with the provided service, and a point of claim context representing one or more channels through which the provided service is provided. The channel module receives a request for a Web page. The application server generates a dynamic Web page using a plurality of default values and overrides at least one of the default values using at least one context from the plurality of contexts.

In another aspect, there is a system for overriding a Web application configuration involving multiple customers. The system includes a means for defining a plurality of contexts for use in dynamic Web page generation associated with a provided service. The plurality of contexts includes an organization context representing one or more customers of the provided service, a role context representing one or more roles used with the provided service, and a point of claim context representing one or more channels through which the provided service is provided. The system includes a means for receiving a request for a Web page. The system includes a means for generating a dynamic Web page using a plurality of default values and overriding at least one of the default values using at least one context from the plurality of contexts.

In other examples, any of the aspects above can include one or more of the following features. The overriding includes determining a first context value associated with the request. The first context value corresponds to a first context from the plurality of contexts. The overriding includes overriding at least one of the default values using the first context value.

In yet other examples, the first context is the role context. The overriding includes overriding at least one of the default values associated with generating tabs to be displayed as part of the Web page.

In other examples, the overriding includes determining a second context value associated with the request. The second context value corresponds to a second context from the plurality of contexts. The second context is different than the first context. The overriding includes overriding at least one of the default values using the second context value.

In yet other examples, the overriding includes determining a third context value associated with the request. The third context value corresponds to a third context from the plurality of contexts. The third context is different than the first context and the second context. The overriding includes overriding at least one of the default values using the third context value.

In other examples, a plurality of product data elements representing the provided service are defined. A priority is associated to each of the defined contexts in the plurality of contexts and to each product data element in the plurality of product data elements. The overriding includes overriding based on the associated priorities corresponding to the product data element associated with the request.

In yet other examples, the plurality of contexts includes a segment context representing a type of customer. The type of customer includes a small volume customer and/or a large scale customer. The organization context includes a company and/or a division of a company. The role context includes an administrator, a manager, and/or an employee.

In other examples, the point of claim context includes a Web site publicly available, a Web site available only to authorized users, and/or a Web site available only to internal employees of a service provider providing the provided service.

In yet other examples, a priority is associated to each of the defined contexts in the plurality of contexts. The overriding includes overriding based on the associated priorities.

In other examples, one or more of the default values correspond to one or more properties, navigation details, and/or links. The context is associated with a context identifier and/or a content type. The provided service is associated with a human resources function.

In yet other examples, a dynamic Web page is generated. The dynamic Web page includes using a JavaSever Page (JSP), hypertext preprocessor (PHP) page, active server page (ASP), and/or ASP.NET. One or more of the default values correspond to one or more attributes of a JSP page associated with the request. One or more of the default values correspond to one or more attributes within a JSP tag. The defining includes using a database to store the defined contexts.

In other examples, the system includes a backend module. The backend module processes the request for the Web page and transmits a response to the request to the application server. The backend module is a service module, a payroll module, and/or a time keeping module.

Implementations can realize one or more of the following advantages. An advantage is that multiple customers each with their own users can each have a Web application customized according to the structures and rules of the customer. Another advantage is that one or more contexts can be defined and utilized to allow the customers to configure different customizations of the applications depending on their needs. Another advantage is that priority can be assigned according to the needs of the customer thus facilitating the customization of the user interface according to the defined contexts. An advantage is that customized interfaces to the application can be used for each user or set of users and the interfaces can utilize common services to communicate with backend servers. One implementation of the invention may provide all of the above advantages.

The details of one or more examples are set forth in the accompanying drawings and the description below. Further features, aspects, and advantages of the invention will become apparent from the description, the drawings, and the claims.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing a multiple customer system for providing outsourced human resource applications.

FIG. 2 is a block diagram showing an exemplary configurable frameset for use in the system.

FIG. 3 is a block diagram showing an exemplary configurable frameset of a human resource manager of a first exemplary company

FIG. 4 is a block diagram showing an exemplary configurable frameset of a human resource manager of a second exemplary company.

FIG. 5 is a block diagram showing a schema for an exemplary configuration data store.

FIG. 6 is a screenshot of context configuration for an exemplary system.

FIG. 7 is a screenshot of role context information for an exemplary system.

FIG. 8 is a screenshot of command information for an exemplary system.

FIG. 9 is a flowchart depicting the processing of user requests through an exemplary system.

### DETAILED DESCRIPTION

In general overview, a user requests a Web page. A dynamic Web page is generated using default values associated with the user. At least one of the default values is overridden by an override value associated with a context. A plurality of contexts are defined for use in the dynamic generation of the Web page. The plurality of contexts include an organization context, a role context, a point of claim context, a service module context, a container context, and/or a segment context.

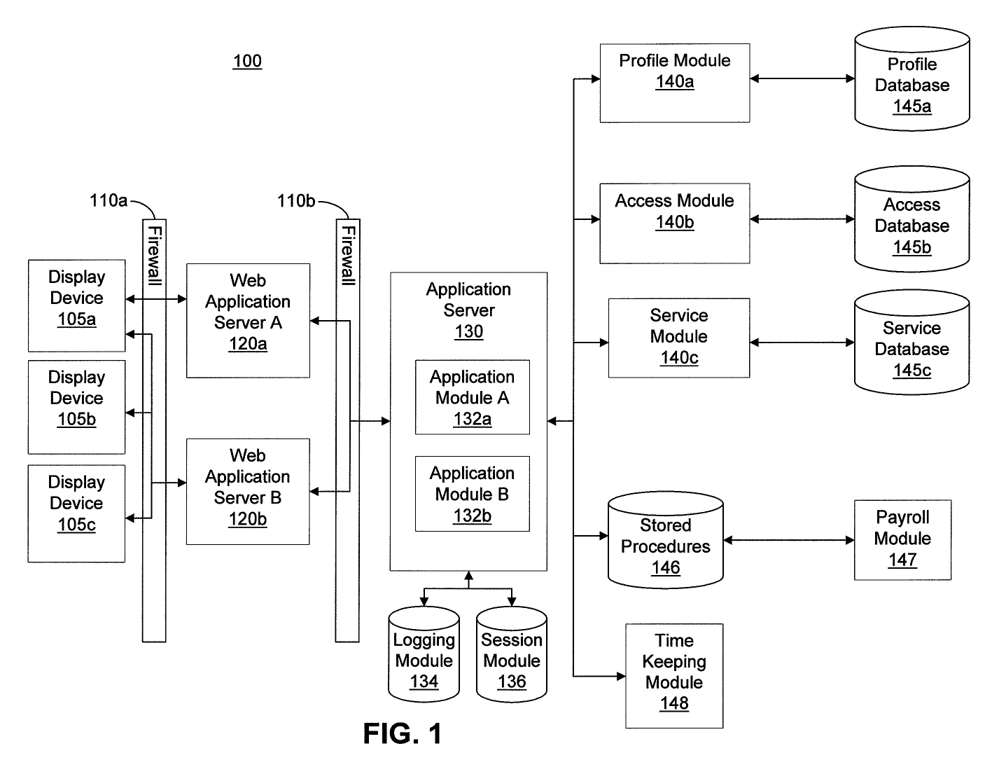

FIG. 1 is a block diagram showing a multiple customer system 100 for providing outsourced human resource applications. A user from a customer makes a request using a display device 105a, 105b, or 105c, generally 105. The request is transmitted through a firewall 110a to one or more web application servers A 120a or B 120b, generally 120. The one or more web application servers 120 process the request and communicate with an application server 130 through a firewall 110b. The application server 130 associates the request with one or more application modules A 132a and B 132b, generally 132. The one or more application modules 132 process the request. A logging module 134 logs the request and a session module 136 records the user's session of activity.

The processing of the request by the one or more application modules 132 includes communicating with a profile module 140a, authenticating the user with an access module 140b, and communicating with one or more other backend modules (e.g., service module 140c, time keeping module 148). The profile module 140a communicates with a profile database 145a to access stored data associated with the presentation, definitions, and configuration of web pages. The access module 140b communicates with an access database 145b to access stored data associated with the authentication of the user. The one or more other backend modules include the service module 140c, a payroll module 147, and a time keeping module 148. The one or more backend modules process the request and if needed, respond to the request. The service module 140c communicates with a service database 145c to access stored data associated with human resource (HR) aspects of the customers of the system 100. The payroll module 147 is accessed by stored procedures 146 which are used to access the payroll module 147. The time keeping module 148 processes and stores data associated with the time keeping of employees. The request is processed and responded to by the one or more backend modules.

The response by the one or more backend modules includes data that the application server 130 uses to respond to the request form the display device 105. The application server 130 receives data associated with the presentation, definitions, and configuration of the web page. The data associated with the presentation, definitions, and configuration of the web page includes, for example, one or more default values and one or more override values associated with a context. The context can, for example, be an organization context representing one or more customers of the provided application, a role context representing one or more roles used with the provided application, and/or a point of claim context representing one or more channels through which the provided application is provided. The application server 130 generates a dynamic Web page using a plurality of the default values. The application server 130 overrides at least one of the default values using override values associated with at least one context from the plurality of contexts. The application server 130 can, for example, receive the override values and/or other values associated with the context. In some examples, the application server 130 does not receive the context from the profile module 140a, but only receives the override values.

In some examples, the overriding of at least one of the default values includes determining a first context value associated with the request and overriding at least one of the default values using the first context value. The first context value corresponds to a first context from the plurality of contexts. The first context can, for example, be a role context. The first context value overrides, for example, a default value associated with generating tabs to be displayed as part of the Web page.

In other examples, the overriding of at least one of the default values includes determining a second context value associated with the request and overriding at least one of the default values using the second context value. The second context value corresponds to a second context from the plurality of contexts and is different than the first context. For example, the first context is an organization context and the second context is a role context.

In some examples, the overriding of at least one of the default values includes determining a third context value associated with the request and overriding at least one of the default values using the third context value. The third context value corresponds to a third context from the plurality of contexts and is different than the first and second contexts. For example, the first context is an organization context, the second context is a role context, and the third context is a point of claim context. An advantage of the exemplary system 100 is that one or more contexts can be defined and utilized to allow the customers of the system 100 to configure different customizations depending on their needs.

A plurality of product data elements (e.g., employee tax information, 401K information) representing the provided application can, for example, be defined. A priority can, for example, be associated with each product data element in the plurality of product data elements and the overriding is based on the associated priorities corresponding to the product data element associated with the request. A priority can, for example, be associated with each of the defined contexts in the plurality of contexts, wherein overriding comprises overriding based on the associated priorities. Another advantage of the system 100 is that priority can be assigned according to the needs of the customer thus facilitating the customization of the user interface according to the defined contexts.

In some examples, the plurality of contexts includes a segment context representing a type of customer. The type of customer can, for example, be a small volume customer and/or a large scale customer. The organization context includes, for example, a company (e.g., North South Company), a division of a company, and/or any other type of part of a business (e.g., Information Technology Department of North South Company). The role context includes, for example, an administrator (e.g., retirement administrator, payroll administrator), a manager (e.g., general manager, human resource manager, information technology manager, legal manager), and/or an employee (e.g., administrative assistant, secretary, attorney, plumber, maintenance worker, custodian, clerk). The point of claim context includes, for example, a Web site publicly available (e.g., Internet), a Web site available only to authorized users (e.g., Extranet), a Web site available only to internal employees of a application provider providing the provided application (e.g., Intranet), and/or the application which accesses the data (e.g., Employee Self Service Portal, Management Portal, Travel Portal, Travel Management Portal). For example, the service module context includes an employee portal, an employer portal, and/or customer portal. The container context includes, for example, part or all of a segment context, an organization context, a role context, a point of claim context, and/or a service module.

The default values can, for example, correspond to one or more properties (e.g., font is red), navigation details (e.g., Web page linked to other pages in the Web site), and/or links (e.g., Web page linked to external Web sites). The default values are, for example, those associated with the page of information requested (e.g., a travel page has a link to a weather website, an employee page has a link to vacation information).

In some examples, the context is associated with a context identifier and/or a content type (e.g., service industry, financial industry). In other examples, the generated dynamic Web page is a JavaSever Page (JSP), hypertext preprocessor (PHP) page, active server page (ASP), and/or ASP.NET. The default values can, for example, correspond to one or more attributes (e.g., tags, actions, tag libraries) of a JSP page associated with the request. The default values can, for example, correspond to one or more attributes (e.g., include, forward, plugin, useBean) within a JSP tag.

Although the exemplary system 100 illustrates three display devices 105a, 105b, and 105c, the system 100 could utilize more than three display devices 105 (e.g., five, twenty, two hundred, five thousand). The display device 105 can, for example, transmit to the web application server 120 through the Internet, an intranet, an extranet, and/or any other type of network configuration. The system 100 could utilize more than two web application servers 120 (e.g., five, ten, twenty) although the exemplary system 100 illustrates two web application servers A 120a and B 120b. The web application servers 120 can, for example, be channels of communication to the system 100 by the users. For example, the web application servers 120 are front end applications that the users access (e.g., human resource application in web application server A 120a and time keeping application in web application server B 120b). The transmission of the request through the system 100 can, for example, be over a circuit based network or a packet based network.

The stored procedures 146 can, for example, be structured query language (SQL) procedures. In some examples, the stored procedures 146 have default values which are associated with the type of data to be accessed in the payroll module 147. In other examples, the default values in the stored procedures 146 can be overridden by override values which are associated with a user's profile stored in the profile database 145a. The override values provide, for example, customized access for the user to data and information stored and accessed through payroll module 147.

The one or more backend servers can, for example, include any type of backend module and/or server. For example, the backend module can be a recruiting module, a compensation planner module, a payroll module, a staffing module, and/or a retirement module. Although the exemplary system 100 illustrates outsourced human resource applications, the system 100 could provide other outsourced applications including intellectual property management, facilities management, software licensing management, and/or travel management.

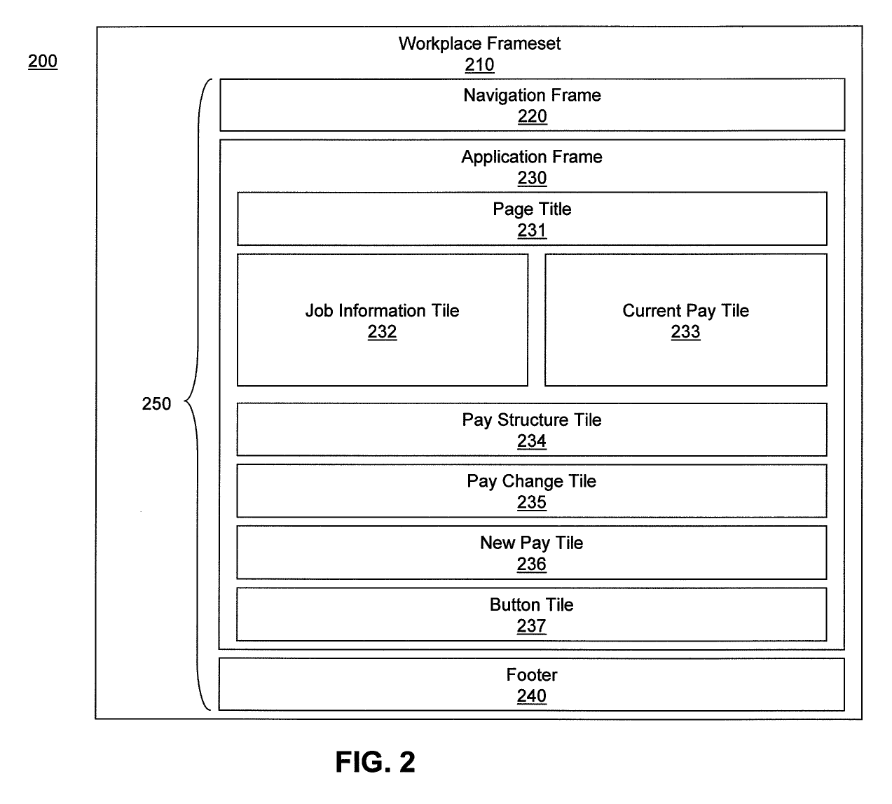

FIG. 2 is a block diagram showing an exemplary configurable frameset 200 for use in the system 100 of FIG. 1. The configurable frameset 200 includes a workplace frameset 210. The workplace frameset 210 includes a navigation frame 220, an application frame 230, and footer 240. The navigation frame 220 includes information and/or links that allow the user to navigate a Web site associated with the Web page. The application frame 230 includes information, links, and/or tiles associated with the application that the user is accessing on the system 100. The footer 240 includes information and/or links associated with the user, the application, the context, and/or the organization.

The navigation frame 220 includes a page tile 231, a job information tile 232, a current pay tile 233, a pay structure tile 234, a pay change tile 235, a new pay tile 236, and a button tile 237. The tiles (e.g., page tile 231) include data and/or information associated with the context. Although the workplace frameset 210 illustrates an outsourced human resource system 100, the workplace frameset 210 can be uses in other outsourced systems as described above. The workplace frameset 210 for an outsourced human resource system 100 is one variation of the frames, information, and/or tiles in the workplace frameset 210, other variations will be readily apparent to those skilled in the art.

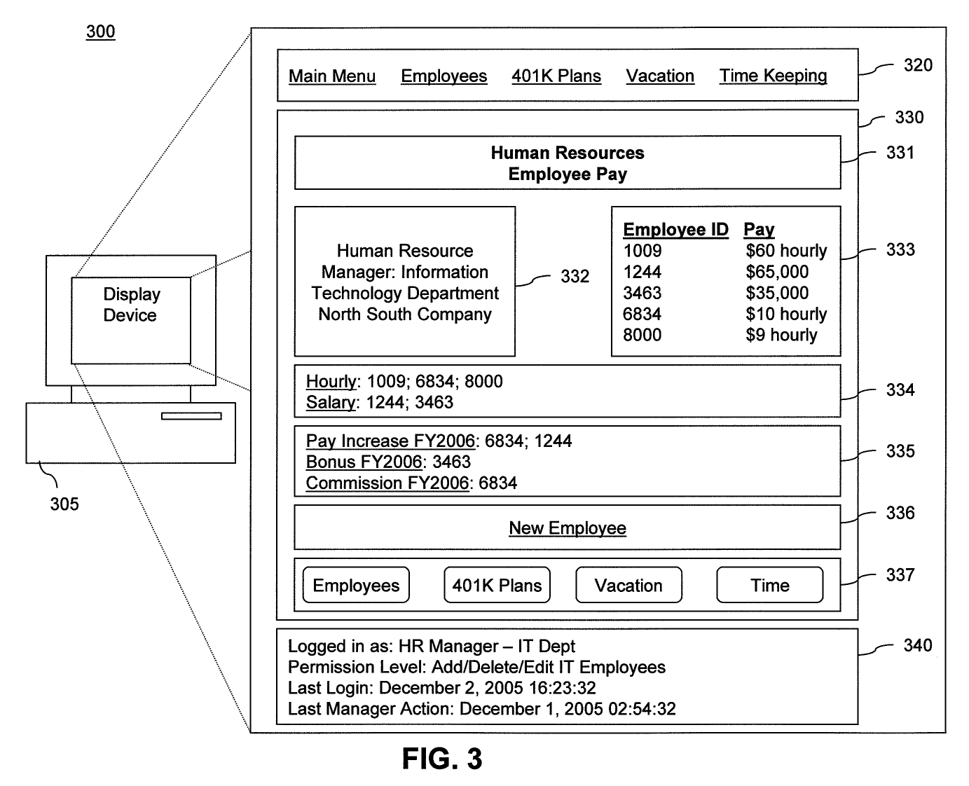

FIG. 3 is a block diagram showing an exemplary configurable frameset 300 in the system 100 of FIG. 1. The configurable frameset illustrates a human resource manager of an information technology department in a exemplary company, North South Company. The user uses a display device 305 to view the configurable frameset 300 that includes a viewable Web page. The configurable frameset 300 includes frames (e.g., navigation frame 320), tiles (e.g., page tile 331), and a footer 340. The frames include the navigation frame 320 which includes links and information associated with the navigation of the Web page through the Web site associated with the web page. The application frame 330 includes a page title 331 which shows the title of the Web page, the job information tile 332 which illustrates the user and the customer information, the current pay tile 333 which illustrates the employees that the user is authorized to view and the employees' pay rate, the pay structure tile 334 which illustrates the classification of the pay structures, the pay change tile 335 which shows the pay changes, the new pay tile 336 which illustrates configuration options for new employees, and the button tile 337 which illustrates the buttons that are available for the user. The footer 340 illustrates information and/or data associated with the user.

For example, the human resource manager makes a request for an employee pay Web page in a human resource Web site using the display device 105c (e.g., 305) connected to the system 100 through an extranet. The request is transmitted through the firewall 110a to the web application server A 120a which includes a human resource application front end. The request is transmitted to the application server 130. The application server 130 associates the human resource request from the human resource application front end in the web application server A 120a to the application module A 132a which includes human resource application middleware. The application module A 132a transmits the request to the service module 140c which processes the request and the profile module 140a which retrieves the profile for the user.

The service module 140c retrieves stored data from the service database 145c and processes the request. The service module 140c transmits a response to the request to the application module A 132a. The profile module 140a retrieves stored data from the profile database 145a, processes the data to generate override values (e.g., Human Resource Manager for Information Technology Department of North South Company has access to 401K plan information), and transmits the override values to the application module A 132a. The application module A 132a receives the response to the request and the override values. Using default values (e.g., all Human Resource Managers have access to Vacation information, but no access to 401K plan information) for the Web page, the application module A 132a generates a dynamic Web page. The application module A 132a processes the override values and overrides the associated default values (e.g., default value of no access to 401K plan information is overridden by override value of access to 401K plan information). The dynamically generated Web page is transmitted to the user's display device 105c (e.g., 305) for viewing by the user.

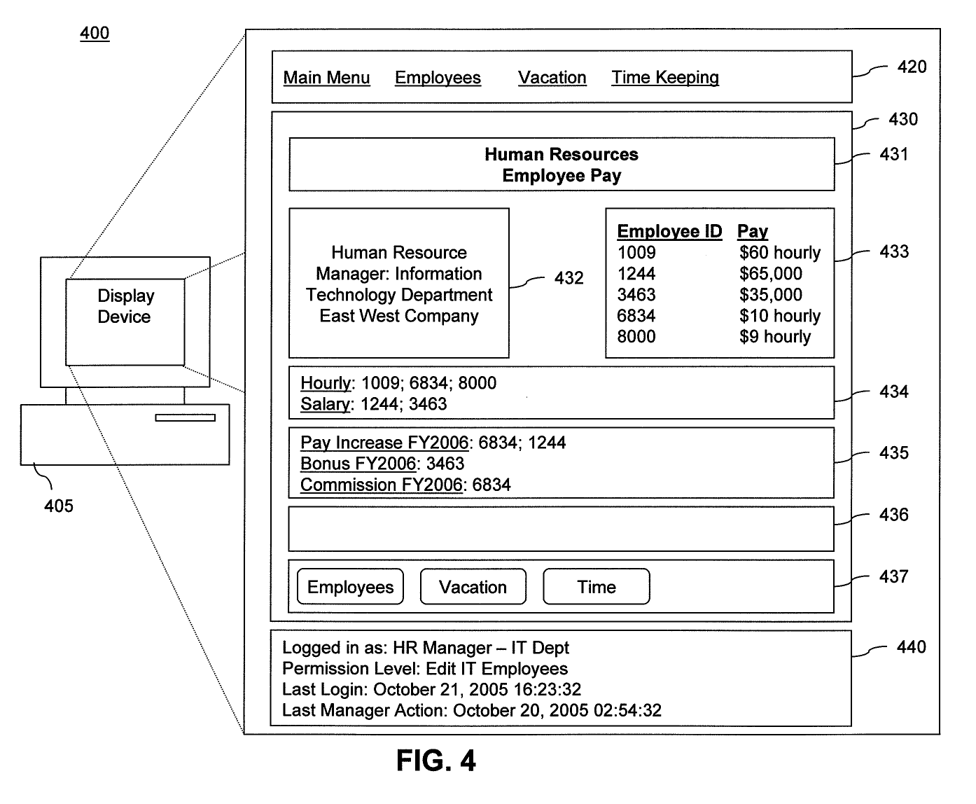

FIG. 4 is a block diagram showing an exemplary configurable frameset 400 in the system 100 of FIG. 1. The configurable frameset illustrates a human resource manager of an information technology department in a second exemplary company, East West Company. The user uses a display device 405 to view the configurable frameset 400 that includes a viewable Web page. The configurable frameset 400 includes frames (e.g., navigation frame 420), tiles (e.g., page tile 431), and a footer 440. The frames include the navigation frame 420 which includes links and information associated with the navigation of the Web page through the Web site associated with the web page. The application frame 430 includes a page title 431 which shows the title of the Web page, the job information tile 432 which illustrates the user and the customer information, the current pay tile 433 which illustrates the employees that the user is authorized to view and the employees' pay rate, the pay structure tile 434 which illustrates the classification of the pay structures, the pay change tile 435 which shows the pay changes, the new pay tile 436 which illustrates configuration options for new employees, and the button tile 437 which illustrates the buttons that are available for the user. The footer 440 illustrates information and/or data associated with the user.

For example, the human resource manager makes a request for an employee pay Web page in a human resource Web site using the display device 105c connected to the system 100 through an extranet. The request is transmitted through the firewall 110a to the web application server A 120a which includes a human resource application front end. The request is transmitted to the application server 130. The application server 130 associates the human resource request from the human resource application front end in the web application server A 120a to the application module A 132a which includes human resource application middleware. The application module A 132a transmits the request to the service module 140c which processes the request and the profile module 140a which retrieves the profile for the user.

The service module 140c retrieves stored data from the service database 145c and processes the request. The service module 140c transmits a response to the request to the application module A 132a. The profile module 140a retrieves stored data from the profile database 145a, processes the data to generate override values (e.g., Human Resource Manager for Information Technology Department of East West Company has access to time keeping information), and transmits the override values to the application module A 132a. The application module A 132a receives the response to the request and the override values. Using default values (e.g., all Human Resource Managers have access to Vacation information, but no access to time keeping information) for the Web page, the application module A 132a generates a dynamic Web page. The application module A 132a processes the override values and overrides the associated default values (e.g., default value of no access to time keeping information is overridden by override value of access to time keeping information). The dynamically generated Web page is transmitted to the user's display device 105c (e.g., 405) for viewing by the user.

The override values can, for example, be associated with different contexts to distinguish which users should receive the override values and which users should receive the default values. For example, the override value of allowing a Human Resource Manager to access 401K plan information is in the organizational context since North South Company allows its Human Resource Managers to have access to 401K plan information but East West Company does not allow its Human Resource Managers to have access to 401K plan information. The override value of allowing Human Resource Managers access to vacation information is, for example, in the role context because all Human Resource Managers are by default allowed access to vacation information. In some examples, the human resource application front end is a point of claim representing the channel in which the provided application, human resource management, is provided. The channel can, for example, be a point of claim context representing how the user accesses the information associated with the application (e.g., user accessing the human resource information through the human resource front end associated with the web application server A 120a).

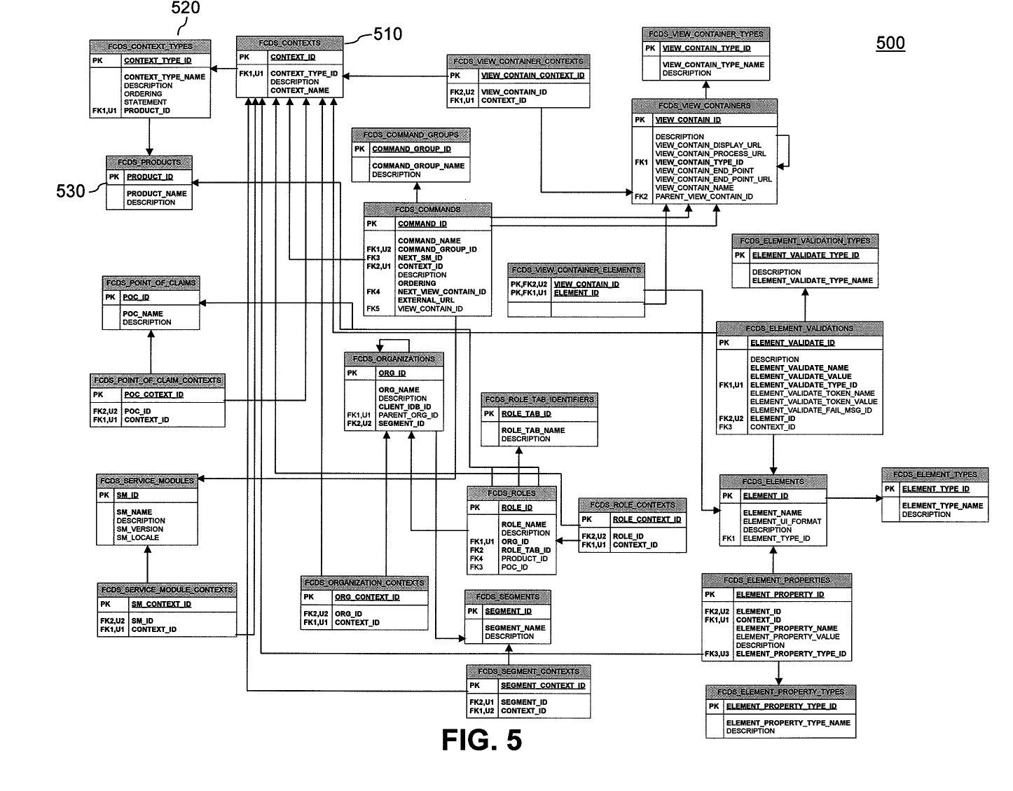

FIG. 5 is a block diagram showing a schema 500 for an exemplary configuration data store. The schema 500 illustrates the organization of the data in the profile database 145a of FIG. 1. The data stored in the profile database 145a is, for example, organized according to the tables and relationships as illustrated by the schema 500. For example, the FCDS_Context_Types 520 (definition of entries illustrated in Table 1) contains information associating FCDS_Products 530 (definition of entries illustrated in Table 2) to FCDS_Contexts 510 (definition of entries illustrated in Table 3) by the relationship between Product_ID which provides the relationship between FCDS_Products 530 and FCDS_Context_Types 520 and Context_Type_ID which provides the relationship between FCDS_Contexts 510 and FCDS_Context_Types 520. Tables 1-3 illustrate the relationships between the tables illustrated in the schema 500. The other tables in the schema 500 can, for example, be associated by their primary and foreign keys as illustrated in FIG. 5.

TABLE 1
FCDS_Context_Type Entries

| Column Name | Data Type | Nullable | Description |
|---|---|---|---|
| CONTEXT_TYPE_ID | Number | No | Sequence |
| | | | Generated Id |
| CONTEXT_TYPE_NAME | Varchar2 | No | Context Type |
| | | | Name |
| ORDERING | Number | Yes | Ordering of the |
| | | | Context Type |
| STATEMENT | Varchar2 | Yes | Statement of the |
| | | | Context Type |
| PRODUCT_ID | Number | No | Product Id |
| DESCRIPTION | Varchar2 | No | Description of the |
| | | | Context Type |

TABLE 2
FCDS_Products Entries

| Column Name | Data Type | Nullable | Description |
|---|---|---|---|
| PRODUCT_ID | Number | No | Sequence Generated Id |
| PRODUCT_NAME | Varchar2 | No | Product Name |
| DESCRIPTION | Varchar2 | Yes | Description of the product |

TABLE 3
FCDS_Context Entries

| Column Name | Data Type | Nullable | Description |
|---|---|---|---|
| CONTEXT_ID | Number | No | Sequence Generated Id |
| CONTEXT_NAME | Varchar2 | No | Context Name |
| CONTEXT_TYPE_ID | Number | No | Context Type Id |
| DESCRIPTION | Varchar2 | Yes | Description of the |
| | | | context |

The tables and associations of the schema 500 provide, for example, a way of organizing and associating the data associated with the contexts used in the exemplary system 100 of FIG. 1. The tables and associations of the schema 500 provide for storage of information relating to contexts including point of claim, roles, and organizations, commands which relate to what a user is allowed to access, view containers which relate to what the user is allowed to view and how that information is presented to the user via the Web page, and elements which relate to what type of information is provided to the user. Although the schema 500 provides for point of claim, role, and organization contexts, other contexts can be utilized by the system 100 for the storage of data associated with the profile of the users, the contexts, and/or data associated with the contexts.

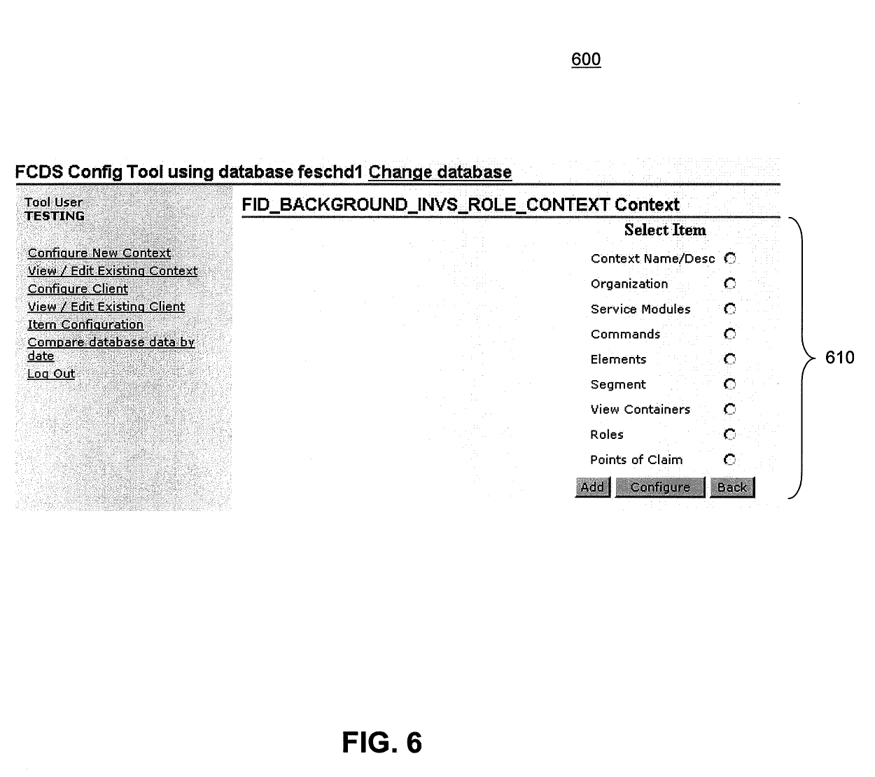

FIG. 6 is a screenshot 600 of context configuration 610 for the exemplary system 100 of FIG. 1. The screenshot 600 illustrates the context configuration 610 for the contexts, commands, and elements for a user. In some examples, the screenshot 600 is from a configuration module that interfaces with the profile module 140a to edit, delete, and/or add data associated with the context to the profile database 145a.

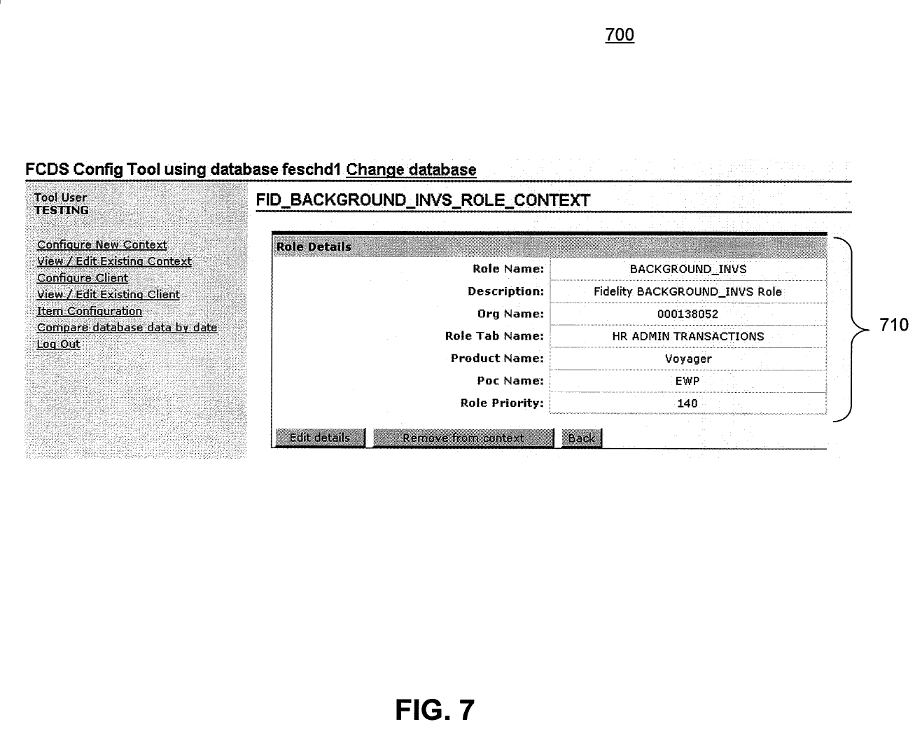

FIG. 7 is a screenshot 700 of role context information 710 for the exemplary system 100 of FIG. 1. The screenshot 700 illustrates the relationship between role, organization, product, and priority for a context. This relationship can be edited according to the needs of the different customers. In some examples, the screenshot 700 is from a configuration module that interfaces with the profile module 140a to edit, delete, and/or add data associated with the context to the profile database 145a.

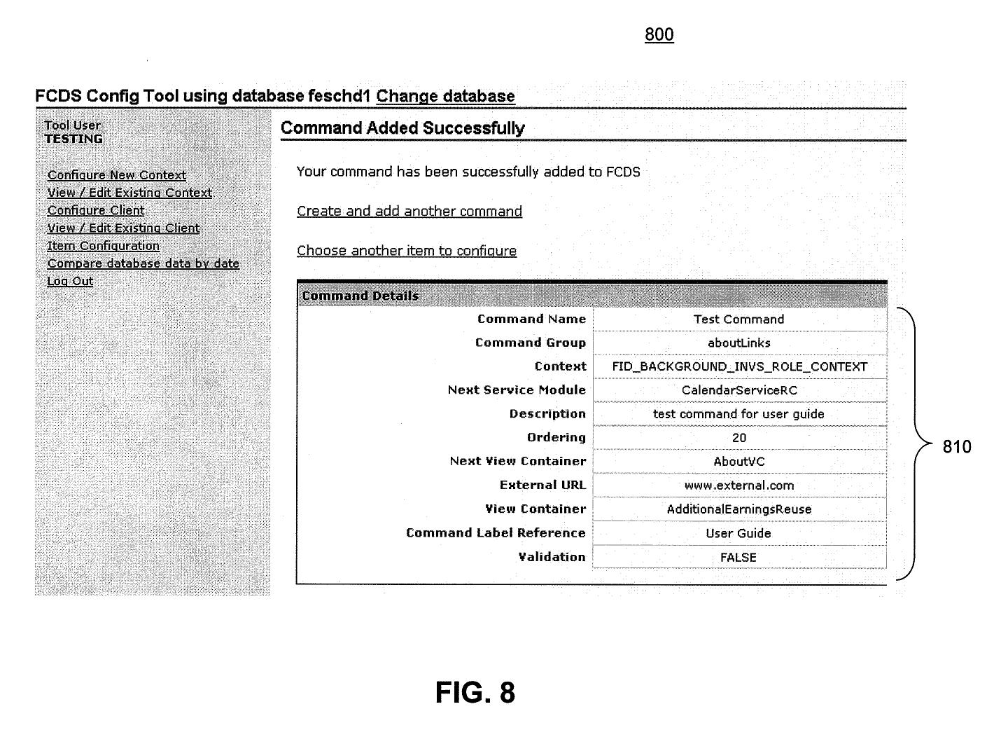

FIG. 8 is a screenshot 800 of command information 810 for the exemplary system 100 of FIG. 1. The screenshot 800 illustrates the configuration of commands available to different users according to their context overrides and default values. In some examples, the screenshot 800 is from a configuration module that interfaces with the profile module 140a to edit, delete, and/or add data associated with the context to the profile database 145a.

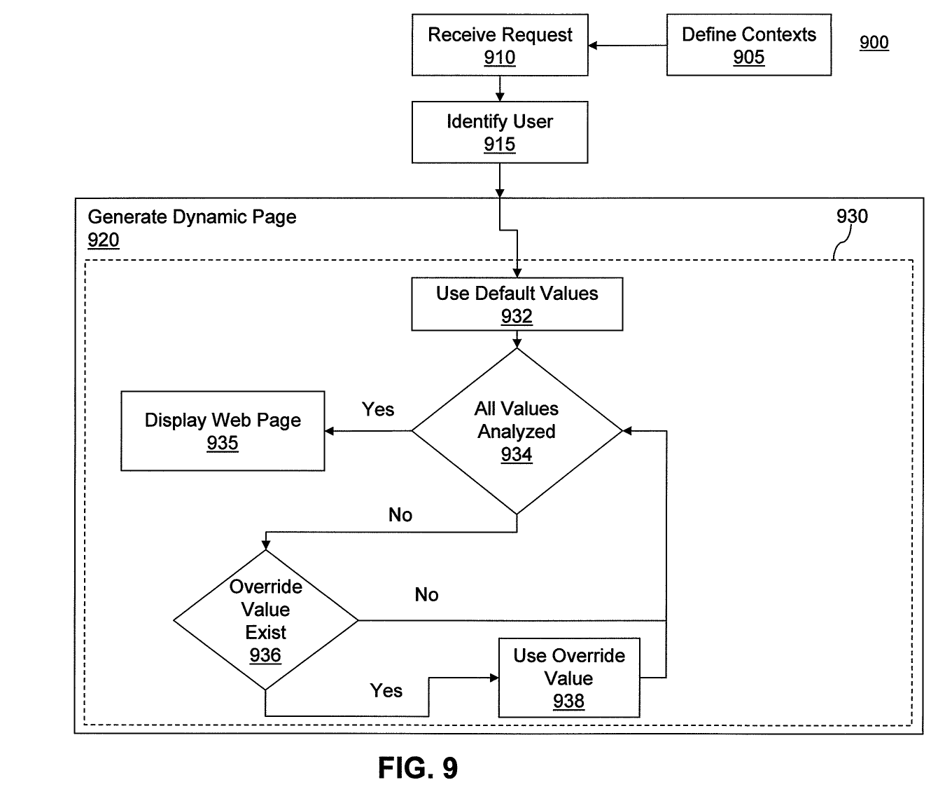

FIG. 9 is a flowchart 900 depicting the processing of user requests through the exemplary system 100 of FIG. 1. The contexts including organization, role, and point of claim contexts are defined (905) by the profile module 140a in the profile database 145a. The web application server 120 receives (910) a request from a user through the display device 105. After receiving the request, the application server 130 communicates with the access module 140b to identify (915) the user. A dynamic Web page is dynamically generated (920). The generation (920) occurs through the processing (930) of the request. The processing (930) includes using default values (932) to generate (920) the Web page. The default values are analyzed (934). If all of the default values have been analyzed (934), then the Web page is displayed (935) on the user's display device 105. If one or more of the default values have not been analyzed (934), then the user's profile is checked to determine if an override value exists (936). If an override value exists (936), then the override valued is used (938) instead of the default value. If no override value exists (936), then the default value is retained.

An administrator of the system 100 of FIG. 1 uses, for example, a display device (e.g., display device 105a) to interface with a configuration profile that edit, deletes, and/or adds data to the profile database 145a. The data in the profile database 145a can, for example, be organized and have associations according to the schema 500 of FIG. 5. The configuration profile as illustrated by the screenshots 600 of FIG. 6, 700 of FIG. 7, and 800 of FIG. 8 provides the administrator with a way to configure the contexts and clients.

For example, the administrator configures North South Company as a new client (e.g., customer) to the outsource human resources system 100 of FIG. 1. The administrator configures the new client by defining (905) contexts and data associated with the contexts for the client (e.g., screenshot 700 of FIG. 7). The configuration for North South Company includes adding the command (e.g., screenshot 800 of FIG. 8) that Human Resource Managers at North South Company have access to 401K plan information. The command is associated with the organizational context of Human Resources Managers at North South Company. When Human Resource Managers at North South Company access the human resource employee information, then the HR managers will have access to the employees 401K plan information.

In some examples, the administrator defines (905) the role context of Human Resource Managers for all clients. The administrator configures the role context by adding the command that Human Resource Managers have access to vacation information. The access to the vacation information is associated with the role of Human Resource Manager so that all Human Resource Managers that access the system 100 will have access to employee vacation information. The role context can, for example, be overridden by an organization context command that a client (e.g., North West Company) does not want its Human Resource Managers to have access to employee vacation information.

In other examples, the administrator defines (905) the point of claim context of access to management functions of the human resource system 100. The user as an employee accesses her information through web application server B 120b (e.g., Employee Front End) and the user as a manager accesses the employee information through web application server A 120a (e.g., Management Front End). The system 100 determines which point of claim that the user is accessing the system 100 through to determine if any point of claim context commands are needed. For example, the user will not be able to access other employee's information through the Employee Front End and will not be able to modify her employee information as the employee through the Management Front End.

For example, the web application server A 120a (e.g., Management Front End) receives (910) a request for employee pay information from the Human Resource Manager of the Information Technology Department of North South Company. The web application server A 120a communicates to the application module B 132b (e.g., Management Middleware) which communicates with the access module 140b to identify (915) the user. The access module 140b communicates with the access database 145b to access stored data about the users of the system 100. The HR Manager—IT Dept. of North South Company is identified (915) by the system 100 as a valid user. The application module B 132b generates (920) a dynamic Web page. The generation (920) includes processing (930) of the default values and any override values associated with the user of the system 100. The processing (930) of the Web page includes using (932) the default values. The default values include the general links and information available to a default user (e.g., the navigation frame 320 for all users provides a link to the main menu). The default user can, for example, be generated from the information associated with the role, organization, and/or point of claim. The default values are analyzed (934). If all of the default values have been analyzed (934), then the Web page is displayed (935) on the display device (e.g., 105a and 305) using the default values that have not been overridden and the override values. If one or more of the default values have not been analyzed (934), then the profile database 145a is checked to determine if an override value exists (936). If an override value does not exist (936), then the default value is used. If an override value does exist (936), then the override value is used (938) (e.g., the override value for the navigation frame 320 under the role context of Human Resource Managers include Employees, Vacation, and Time Keeping links and under the organizational context of North South Company includes 401K Plans).

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a display device. The components of the system can be interconnected by any form or medium of digital data communication (e.g., a communication network). Examples of communication networks include a local area network (LAN), a wide area network (WAN), the Internet, wired networks, and/or wireless networks.

The display device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized method for overriding a Web application configuration involving multiple customers, the method comprising:
defining a plurality of contexts for use in dynamic Web page generation associated with a provided application, the plurality of contexts including an organization context representing one or more customers of the provided application, a role context representing one or more roles used with the provided service, and a point of claim context representing one or more channels through which the provided application is provided;
receiving a request for a Web page;
generating a dynamic Web page using a plurality of default values; and
overriding at least one of the default values using at least one context from the plurality of contexts.

2. The method of claim 1, wherein overriding comprises:
determining a first context value associated with the request, the first context value corresponding to a first context from the plurality of contexts; and
overriding at least one of the default values using the first context value.

3. The method of claim 2, wherein the first context is the role context, and wherein overriding comprises overriding at least one of the default values associated with generating tabs to be displayed as part of the Web page.

4. The method of claim 2, wherein overriding comprises:
determining a second context value associated with the request, the second context value corresponding to a second context from the plurality of contexts, the second context being different than the first context; and
overriding at least one of the default values using the second context value.

5. The method of claim 4, wherein overriding comprises:
determining a third context value associated with the request, the third context value corresponding to a third context from the plurality of contexts, the third context being different than the first context and the second context; and
overriding at least one of the default values using the third context value.

6. The method of claim 1, further comprising defining a plurality of product data elements representing the provided service.

7. The method of claim 6, further comprising associating a priority to each of the defined contexts in the plurality of contexts and to each product data element in the plurality of product data elements, wherein overriding comprises overriding based on the associated priorities corresponding to the product data element associated with the request.

8. The method of claim 1, wherein the plurality of contexts comprise a segment context representing a type of customer, the type of customer including a small volume customer, a large scale customer, or combinations thereof.

9. The method of claim 1, wherein the organization context comprises a company, a division of a company, or combinations thereof.

10. The method of claim 1, wherein the role context comprises an administrator, a manager, an employee, or combinations thereof.

11. The method of claim 1, wherein the point of claim context comprises a Web site publicly available, a Web site available only to authorized users, a Web site available only to internal employees of a service provider providing the provided service, or combinations thereof.

12. The method of claim 1, further comprising associating a priority to each of the defined contexts in the plurality of contexts, wherein overriding comprises overriding based on the associated priorities.

13. The method of claim 1, wherein one or more of the default values correspond to one or more properties, navigation details, links, or combinations thereof.

14. The method of claim 1, wherein the context is associated with a context identifier, a content type, or combinations thereof.

15. The method of claim 1, wherein the provided service is associated with a human resources function.

16. The method of claim 1, wherein generating a dynamic Web page comprises using a JavaSever Page (JSP), hypertext preprocessor (PHP) page, active server page (ASP), ASP.NET, or combinations thereof.

17. The method of claim 16, wherein one or more of the default values correspond to one or more attributes of a JSP page associated with the request.

18. The method of claim 17, wherein one or more of the default values correspond to one or more attributes within a JSP tag.

19. The method of claim 1, wherein defining comprises using a database to store the defined contexts.

20. A computer program product, tangibly embodied in an information carrier, for overriding a Web application configuration involving multiple customers, the computer program product including instructions being operable to cause data processing apparatus to:
define a plurality of contexts for use in dynamic Web page generation associated with a provided service, the plurality of contexts including an organization context representing one or more customers of the provided service, a role context representing one or more roles used with the provided service, and a point of claim context representing one or more channels through which the provided service is provided;
receive a request for a Web page;
generate a dynamic Web page using a plurality of default values; and
override at least one of the default values using at least one context from the plurality of contexts.

21. A system for overriding a Web application configuration involving multiple customers, the system comprising a computing device configured to:
a profile service module configured and adapted to define a plurality of contexts for use in dynamic Web page generation associated with a provided service, the plurality of contexts including an organization context representing one or more customers of the provided service, a role context representing one or more roles used with the provided service, and a point of claim context representing one or more channels through which the provided service is provided;
a channel module configured and adapted to receive a request for a Web page; and
an application server configured and adapted to generate a dynamic Web page using a plurality of default values and override at least one of the default values using at least one context from the plurality of contexts.

22. The system of claim 21, further comprising:
a backend module configured and adapted to process the request for the Web page and transmit a response to the request to the application server.

23. The system of claim 22, wherein the backend module is a service module, a payroll module, a time keeping module, or combinations thereof.

24. A system for overriding a Web application configuration involving multiple customers, the system comprising:
a means for defining a plurality of contexts for use in dynamic Web page generation associated with a provided service, the plurality of contexts including an organization context representing one or more customers of the provided service, a role context representing one or more roles used with the provided service, and a point of claim context representing one or more channels through which the provided service is provided;
a means for receiving a request for a Web page; and
a means for generating a dynamic Web page using a plurality of default values and overriding at least one of the default values using at least one context from the plurality of contexts.
